(19) United States
(12) Patent Application Publication
(10) Pub. No.: US 2002/0163807 A1
(43) Pub. Date: Nov. 7, 2002

(54) Lamp body structure in good appearance and for aiding the vision

(76) Inventors: Wen-Horng Lee, Taichung Hsien (TW); Po-Chieh Lee, Taichung Hsien (TW)

Correspondence Address: LEE, Wen-Horng & LEE, Po-Chieh, P.O. Box No.6-57, Chung-Ho City, Taipei Hsien, 235, TW

(21) Appl. No.: 09/848,328

(22) Filed: May 4, 2001

(51) Int. Cl. F21V 33/00

(52) U.S. Cl. 362/253; 362/413

(57) ABSTRACT

The invention herein relates to a lamp body structure in good appearance and for aiding the vision, more specifically a lamp body structure using a convex lens added to the upper portion on the outer rim of the lamp seat shell with innovative and electricity-saving arc light bulb installed inside the lamp seat shell as the main operation bodies; the structure of the lamp seat adapting to the variation of the lamp bracket is not only in good appearance, but also is capable of changing the lamp bracket structure according to the need of aiding the user's vision; when in use, the user views from the upper portion of the convex lens for directly observing the object being used and placed under the light bulb to increase the user's convenience so as to overcome the shortcomings of heating or being too bright caused by the prior light source.

### BACKGROUND OF THE INVENTION

1) Field of the Invention

The invention herein relating to a lamp body structure in good appearance and for aiding the vision, more specifically a lamp body structure using a convex lens added to the upper portion on the outer rim of the lamp seat shell with innovative and electricity-saving arc light bulb installed inside the lamp seat shell as the main operation bodies with the structure of the lamp seat assembled to adapt the variation of the lamp bracket, is a lamp body structure possessing the effect of being in good appearance and aiding the vision.

2) Description of the Proir Art

The era passing through the Millennium 2000 can be called the era of high-tech. None of the aspects in ordinary life, at work, of the leisure activities, etc., can deviate from the management field of the high-tech. However, in the matured modern high-tech, the usage of the light source related to the electronic industry, the semi-conductor, the biochemical experiment has not yet been controlled specifically. Furthermore, for the far-sighted elders, the problems of being unable to clearly see the printed words or handle other tiny objects such threading a needle are the part of the main issues studied by those pioneers of the optical and ophthalmic manufacturing who committing on searching for the strategies. However, examining the familiar related structure in the present technique field, there is no any efficient structure capable of solving the key problems of the related manufacturing. One of the structures proposed by one of the pioneers of the optical and ophthalmic manufacturing is assembled by a sandwich magnifier and a light source. However, this type of magnifying and light-penetrating structure tends to injure the eyes since the light source may generate overheat and the light may be too strong, therefore, it can't be operated efficiently and thus has no practicality.

### SUMMARY OF THE INVENTION

In viewing of the above shortcomings, the inventor of the invention herein, after many tests and experiments, aims to invent a structure capable of aiding the vision and enhancing the supplement of the light source, not only eliminating the chance of hurting the vision due to overheat and too strong light, but being able to increase and enhance the practicality of the original lamp body; furthermore, the idea of the design of the invention herein can be further remodeled as a desk lamp, a wall lamp or even as a floor lamp; with such an unique and innovative structure, not only the manufacturing of related technique can be enhanced, the safety and readability can also be increased due to the operating structure of the electricity-saving arc light bulb.

Therefore, the invention herein is not only a real perfect patent, but also a invention with complementary and auxiliary function. To enable a further understanding of the structure, method, spirit and other objectives of the invention herein, the brief description of the drawings below is followed by the detailed description of the preferred embodiment.

### BRIEF DESCRIPTION OF THE DRAWINGS

FIG. 1 is a pictorial and isometric drawing of the external view of the preferred embodiment of the invention herein.

FIG. 2 is a pictorial and exploded drawing of the preferred embodiment of the invention herein.

FIG. 3 is a pictorial and exploded drawing of the lamp seat of the invention herein.

FIG. 4 is an enlarged drawing of the side view of the central section of the holding frame seat of the invention herein.

FIG. 5 is a bottom view of the lamp body of the invention herein.

FIG. 6 is a pictorial drawing of the side view of the preferred embodiment of the invention herein.

FIG. 7 is a pictorial drawing of the top view of the preferred embodiment of the invention herein.

FIG. 8 is a drawing of another preferred embodiment of the invention herein.

FIG. 9 is also a drawing of another preferred embodiment of the invention herein.

### DETAILED DESCRIPTION OF THE PREFERRED EMBODIMENTS

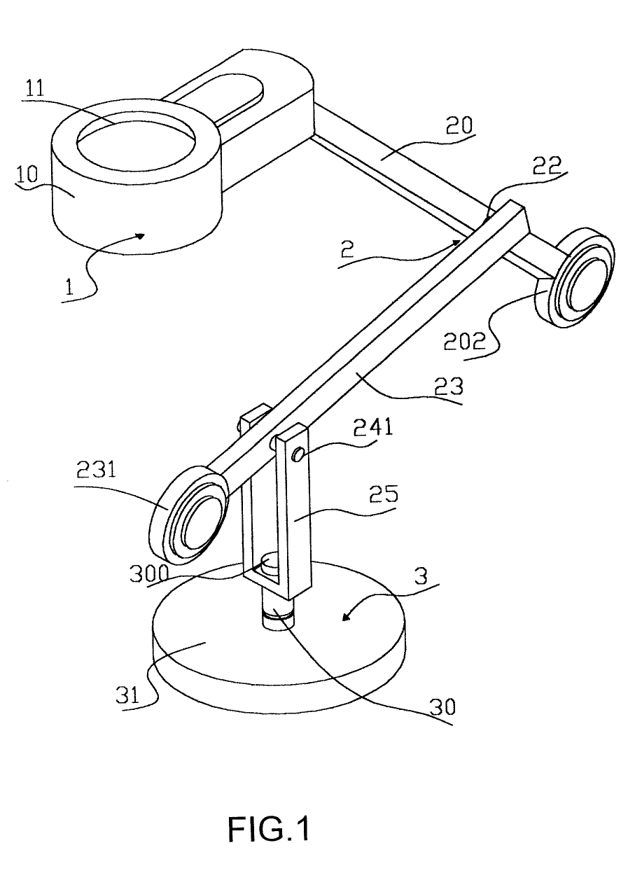

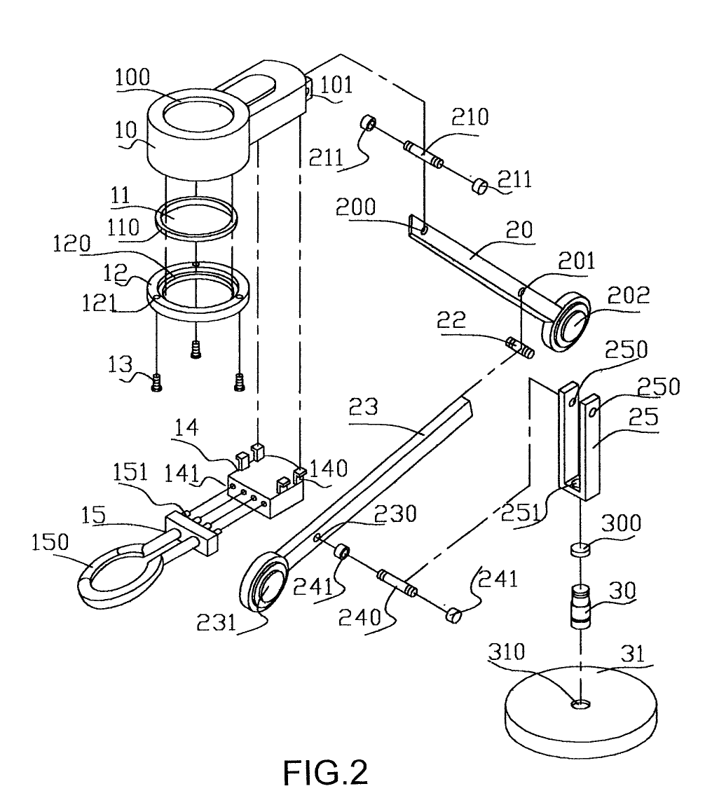

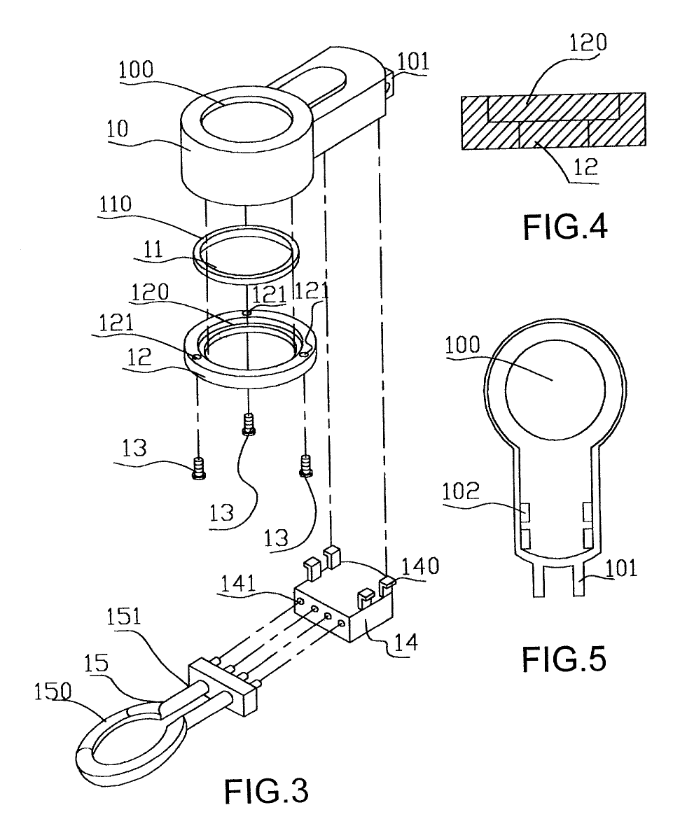

Referring to FIGS. 1, 2, 3, 4, 5 and 6, the invention herein of the lamp body structure in good appearance and for aiding the vision mainly composes of a lamp body (1) with a set of lamp bracket (2) and a set of base seat (3), wherein, a lamp body (1) consists of a lamp housing (10), with round opening hole (100) at the front end and a retaining hole body (101) at the rear end of the lamp housing (10) and several retaining holes (102) mounted on the side surface on the rear end portion inside the lamp housing (10).

A magnifier (11) extended to the circumference (110) can be just placed in the holding frame seat (12) and threaded to the lamp housing (10) around the round opening hole (100) by the screws (13) and projects at the round opening hole (100) in a tightly connected state.

An annular column-shaped holding frame seat (12) has hold bearings (120) in the shape of concaved column surface on the inner rim surface of the column; the side view of the central section shows them exactly as two symmetric and opposite steps; the hold bearings (120) can just hold on the extended circumference (110) the magnifier (11); several screw holes (121) are mounted on the external rim surface of the holding frame seat (12) for the screws (13) to thread the holding frame seat (12) and the magnifier (11) on the hold bearings (120) into the lamp housing (10) to finish the assembly.

The innovational and electricity-saving arc light bulb (I5) is assembled by the arc light bulb (150) and the electric source plug (151); the approximate ratio of the brightness between the innovational electricity-saving arc light bulb (15) and the fluorescent lamp is from 4:1 to 4.5:1; the innovational and electricity-saving arc light bulb (15) fits exactly with the arc lamp housing without influencing the view as the user looking downwards; the electric source plug (151) matches with the plug box case (14) on the rear portion of the innovational and electricity-saving arc light bulb (15); in assembling, one only needs to first insert the electric source plug (15) accordingly into the socket hole (141), then retain tightly the retaining tenons (140) to the retaining holes (102) on the inner rim of the lamp housing (10).

After assembling the lamp body (1), the retaining hole body (101) will overlap the upper hole (200) on the upper supporting bracket (20) and both are penetrated and connected by the first rotary axis (210); two nuts (211) of the first rotary axis (210) are threaded to fix respectively from the two ends on the first rotary axis (210); the lower hole (201) on the upper supporting bracket (20) and the lower supporting bracket (23) is penetrated and connected by the second rotary axis (22) similar to the first rotary axis (210); the lower supporting bracket (23) goes through and laps the centers of the two supporting seats of the U-shaped bearing seat (25); being lapped, the lower supporting bracket hole (230) and the two holes (250) on the U-shaped bearing seat (25) match each other and are penetrated by the third rotary axis (240) similar to the first rotary axis (210) and fixed by two nuts (241) respectively from the two ends; after connecting the lamp body (1) and the lamp bracket (2), the entire lamp bracket (2) is capable of moving freely as a mechanic arm for adjusting the height of the lamp body (1); furthermore, the distal ends on both the upper supporting bracket (20) and the lower supporting bracket (23) are respectively disposed by the weight distributing balls (202, 231) for the leverage.

A hole (251) is mounted on the lower portion of the U-shaped bearing seat (25) of the lamp bracket (2); the size of the diameter of the hole (251) just allows the penetration of a bearing (30); the top end of the bearing (30) can be fixed by a bearing nut (300); the bearing (30) on the base seat (3) extends downwards and is received at the base seat hole rim (310) on the base seat (31); after connecting the lamp bracket (2) and the base seat (3), the bearing (30) can move freely with the lamp bracket (2) as a mechanic arm with the function of rotating freely for adjusting the plane position of the lamp body (1).

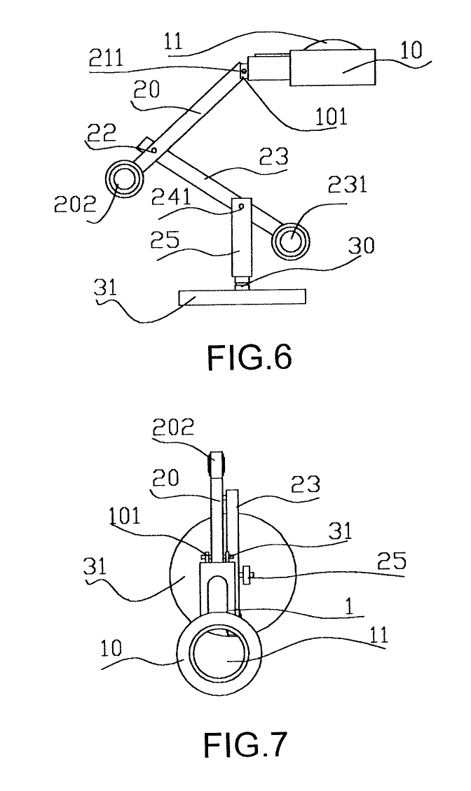

After assembling the lamp body structure in good appearance and for aiding the vision, as shown in FIG. 6, the user needs only to adjust the lamp body (1) to a curtain position and view down from the top to achieve the effect of obtaining the vision aid and being provided by the enough but not eyehurting light source.

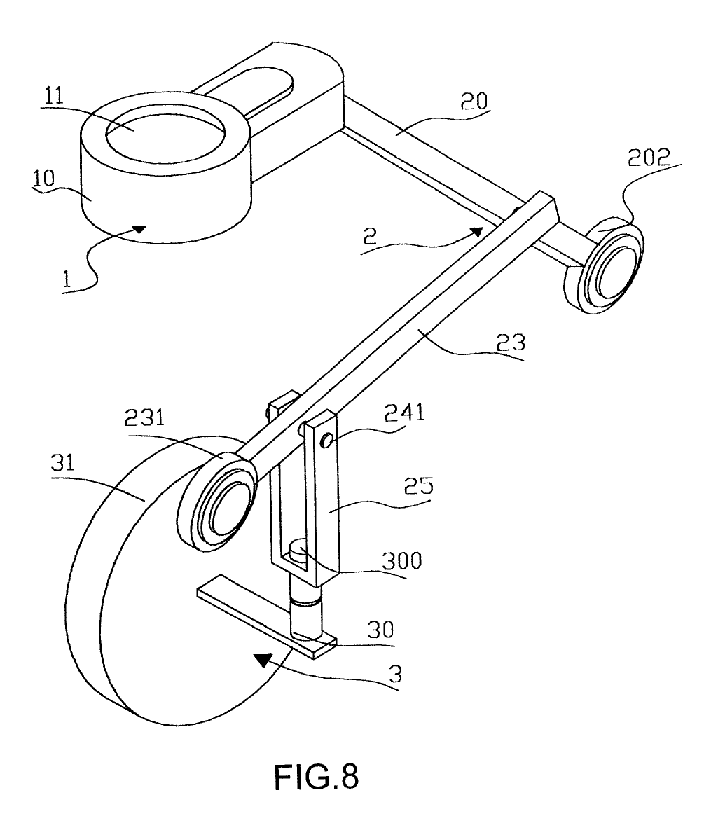

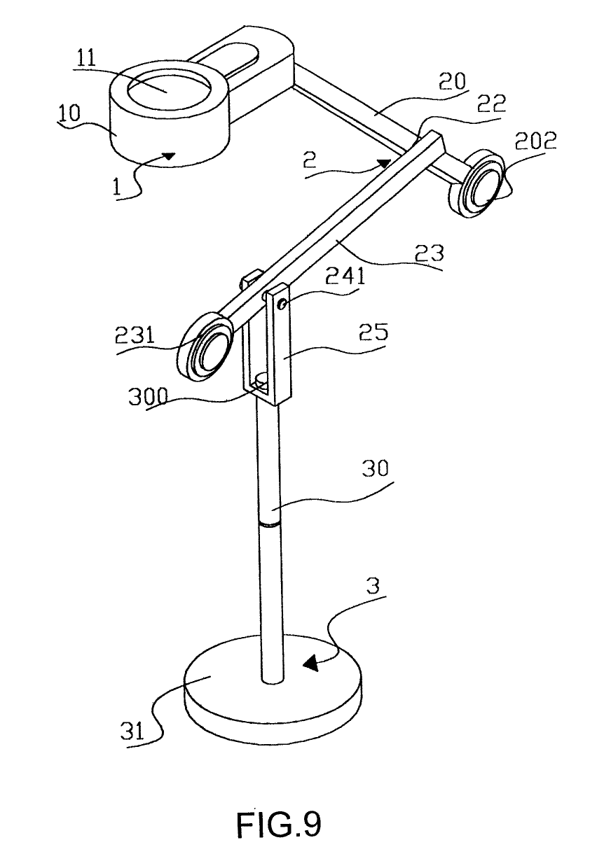

Referring to FIGS. 7 and 8 of the lamp body structure in good appearance and for aiding the vision, at the time of finishing the product, the user or the manufacturer can adjust the length and the shape of the bearing (30) based on the personal need; in addition to being used as an ordinary desk lamp for the electronic industry, the semi-conductor, the biochemical experiment or the auxiliary reading tool for the elders, the product can also be finished as a wall lamp or a floor lamp to more increase the completeness of the function of the invention herein.

In summation of the foregoing sections, the invention herein not only possesses innovative concept and structure, but also has not been preceded by other patents; the invention herein is an improved invention of progress and more especially is a structure with simple embodiment to achieve predictable effect of getting rid of the shortcomings of the conventional structure and is endowed with broad practicability; therefore, the invention herein, possessing not only the innovative key components, but also the double value of being progressive and practical, complies with all the new patent application requirements and is thereby submitted to the patent bureau for review and granting of the commensurate patent rights.

1. The invention herein of a lamp body structure in good appearance and for aiding the vision composes of a lamp body with a lamp bracket supporting rod connected at the rear end for adjusting the height and a base seat with a rotary bearing is characterized that a lamp body mainly consists of innovational and electricity-saving arc light bulb with a lamp housing mounted with a round opening hole to be retained and fixed with a holding frame seat mounted with a magnifier with extending circumference to the top rim of the lamp housing to form a tight connection with the magnifier projecting at the round opening hole to define a lamp body with magnifying effect.

2. As mentioned in claim 1 of a lamp body structure in good appearance and for aiding the vision, wherein, after the lamp body is assembled, the retaining hole body on the read end of the lamp housing just overlaps the upper hole on the upper supporting bracket; the first rotary axis goes through and connects the holes; two nuts of the first rotary axis are respectively fixed on the two ends of the first rotary axis; the lower hole on the upper supporting bracket and the lower supporting bracket are connected by the second rotary axis similar to the first rotary axis; the lower supporting bracket goes through and laps the center of two supporting seats of the U-shaped bearing seat; being lapped, the hole on the lower supporting bracket and the two holes on the U-shaped bearing seat opposite and match each other; the third rotary axis similar to the first rotary axis goes through the holes and hold them in position; two nuts are respectively fixed on the two ends; after assembling the lamp body and the lamp bracket, the entire lamp bracket looks like a mechanical arm;
a hole and a bearing with the diameter in the size for just going through the hole are mounted on the lower portion of the U-shaped bearing seat of the lamp bracket; a bearing nut is fixed on the upper end of the bearing; the bearing of the base seat extends downwards to be received on the hole rim of the base seat.

3. As mentioned in claim 1 of a lamp body structure in good appearance and for aiding the vision, wherein, the length and the shape of the bearing can be adjusted according to the request; in addition to being used as an ordinary desk lamp for the electronic industry, the semiconductor, the biochemical experiment and the auxiliary reading tool for the elders, it can also be finished as a wall lamp or a floor lamp.
